(19) United States
(12) Patent Application Publication
(10) Pub. No.: US 2017/0068542 A1
(43) Pub. Date: Mar. 9, 2017

(54) PROCESSOR AND STORE INSTRUCTION CONVERSION METHOD

(71) Applicant: NEC Corporation, Tokyo (JP)

(72) Inventor: Satoru TAGAYA, Tokyo (JP)

(73) Assignee: NEC Corporation, Tokyo (JP)

(21) Appl. No.: 15/230,930

(22) Filed: Aug. 8, 2016

(30) Foreign Application Priority Data
Sep. 9, 2015 (JP) 2015-177652

(51) Int. Cl. G06F 9/30

(52) U.S. Cl. CPC G06F 9/30181; G06F 9/30043

(57) ABSTRACT

A processor includes a converter configured to convert a first store instruction into a load-store instruction when a branch instruction yet to be executed exists, the first store instruction being an instruction to write first data into a predetermined address and the load-store instruction being an instruction to sequentially execute reading of second data stored in the address and writing of the first data into the address.

This application is based upon and claims the benefit of priority from Japanese Patent Application No.2015-177652, filed on Sep. 9, 2015, the disclosure of which is incorporated herein in its entirety by reference.

### TECHNICAL FIELD

The present invention relates to a processor and a method for converting a store instruction.

### BACKGROUND ART

With respect to processors, there have been studies on enabling data writing into a memory hierarchy in a speculative state (a state where the preceding branch instruction has not been executed yet), in order to hide the latency of a long-latency instruction.

Japanese Patent Application Laid-open Publication No. 11-512855 (Published Japanese translation of PCT application PCT/U.S.96/15419) discloses a technology relating to control of OUT-OF-ORDER execution of load/store operations where an execution engine includes a store queue.

Japanese Patent Application Laid-open Publication No. 2005-284343 discloses a storage apparatus with a redundant disk array unit, in which a first disk-array control unit is capable of using a cache memory of a second disk-array control unit.

### SUMMARY

The primary objective of the present invention is to provide a processor or the like which enables store operation in a speculative state by means of a simple configuration.

A processor according to one aspect of the present invention includes a converter configured to convert a first store instruction into a load-store instruction when a branch instruction yet to be executed exists, the first store instruction being an instruction to write first data into a predetermined address and the load-store instruction being an instruction to sequentially execute reading of second data stored in the address and writing of the first data into the address.

A store instruction conversion method according to one aspect of the present invention includes converting a first store instruction into a load-store instruction when a branch instruction yet to be executed exists, the first store instruction being an instruction to write first data into a predetermined address and the load-store instruction being an instruction to sequentially execute reading of second data stored in the address and writing of the first data into the address, holding information indicating a relationship between the address and information about a register storing the second data read by the load-store instruction, and generating a second store instruction to write the second data into the address if prediction about branching of the branch instruction failed.

### BRIEF DESCRIPTION OF THE DRAWINGS

Exemplary features and advantages of the present invention will become apparent from the following detailed description when taken with the accompanying drawings in which:

FIG. 1 is a diagram showing a processor in a first exemplary embodiment of the present invention;

FIG. 2 is a diagram showing an example of a configuration of an instruction conversion unit of the processor in the first exemplary embodiment of the present invention;

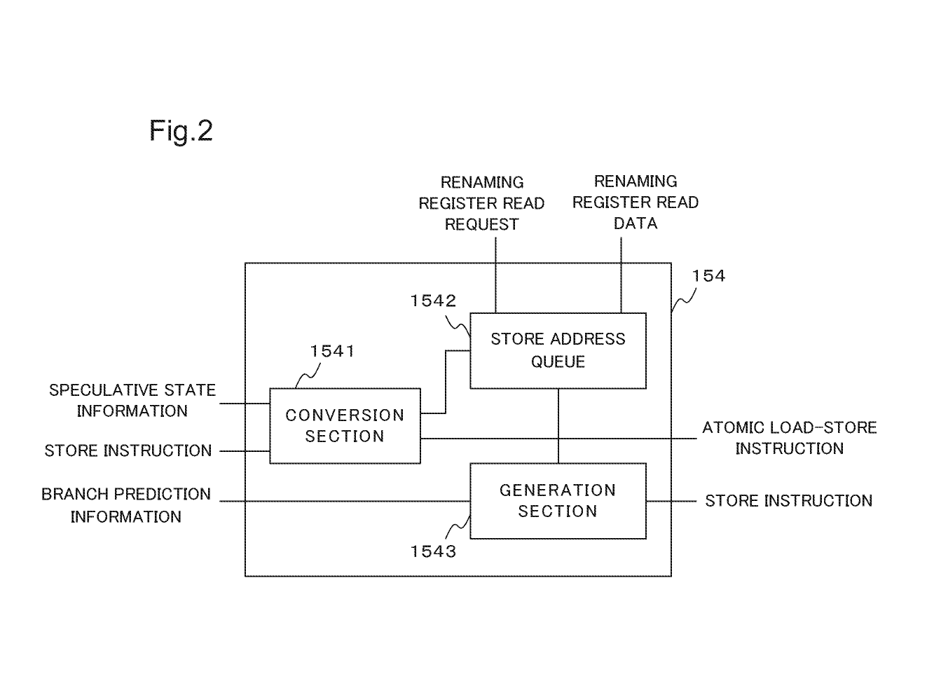

FIG. 3 is a diagram showing an example of a program executed by the processor in the first exemplary embodiment of the present invention;

FIG. 4 shows an example of an machine language level instruction sequence into which the program shown in FIG. 3 was compiled;

FIG. 5 shows an example of a timing chart in a case where an instruction conversion unit provided in a processor core of the processor in the first exemplary embodiment of the present invention is disabled;

FIG. 6 shows an example of a timing chart in a case where the instruction conversion unit provided in a processor core of the processor in the first exemplary embodiment of the present invention is enabled;

FIG. 7 is a diagram showing correspondence of instructions to be executed with entries in a renaming register of the processor in the first exemplary embodiment of the present invention; and

FIG. 8 is a diagram showing an example of information stored in a store address queue of the processor in the first exemplary embodiment of the present invention.

### EXEMPLARY EMBODIMENT

(First Exemplary Embodiment)

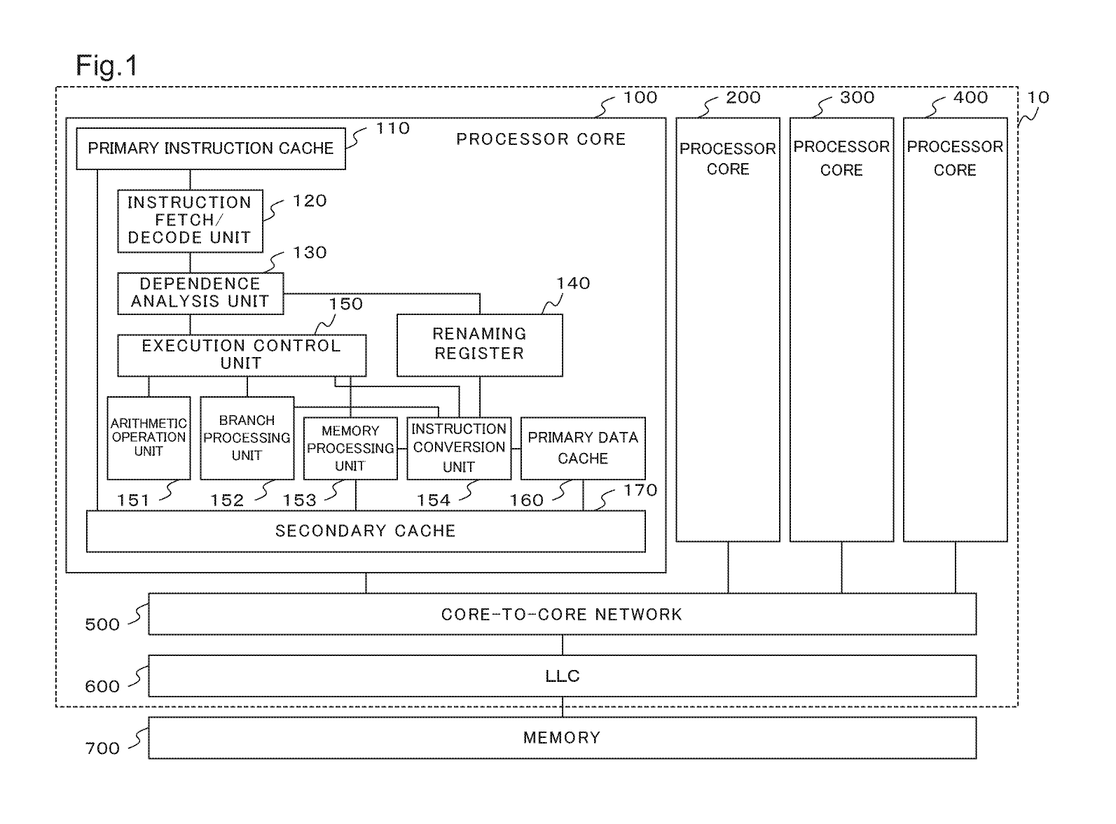

A first exemplary embodiment of the present invention will be described below, with reference to the accompanying drawings. FIG. 1 is a diagram showing a configuration of a processor 10 in the first exemplary embodiment of the present invention. The processor 10 is used in various kinds of information processing devices and the like.

As shown in FIG. 1, the processor 10 in the first exemplary embodiment of the present invention includes processor cores 100 to 400, a core-to-core network 500 and an LLC (Last Level Cache) 600. The processor cores 100 to 400 have the same configuration. In the example shown in FIG. 1, that configuration is shown only for the processor core 100. The processor 10 employs release consistency basically, as its memory consistency model. The core-to-core network 500 connects the processor cores 100 to 400 with each other, and also connects them with the LLC 600. As the core-to-core network 500, a bus with an optional configuration is used, for example. The LLC 600 works as a third level cache of the processor cores 100 to 400. The processor 10 is connected also with a memory 700 working as an external main memory. The memory 700 may be a DRAM (Dynamic Random Access Memory), or may be a non-volatile memory or any other kind of memory.

The processor core 100 includes an instruction fetch/decode unit 120, a dependence analysis unit 130, a renaming register 140, an execution control unit 150, an arithmetic operation unit 151, a branch processing unit 152, a memory processing unit 153 and an instruction conversion unit 154. The instruction conversion unit 154 includes a conversion section 1541, a store address queue 1542 and a generation section 1543. The processor core 100 further includes, as its cache memories, a primary instruction cache 110, a primary data cache 160 and a secondary cache 170.

Here, the configuration of the processor 10 shown in FIG. 1 is merely an example. In the present exemplary embodiment, various configurations can be considered as that of the processor 10, while keeping the instruction conversion unit 154 provided there. For example, the number of cores in the processor 10 is optional. The processor 10 may have only one core, that is, may be a single-core processor. In that case, the processor core 100 (or, the processor core 100 with the LLC 600) can be regarded as the processor 10. Further, the cache configuration may be different from that described above. The processor 10 may have caches of a larger number of levels than in the configuration shown in FIG. 1, or may have a configuration where some of the caches shown in FIG. 1 is eliminated.

Next, each of the constituent elements of the processor core 100 will be described.

The primary instruction cache 110 is a cache memory which holds instruction code stored in the memory 700 as a cache. The primary instruction cache 110 has a capacity of, for example, about 64 KB (kilo-bytes). However, the capacity of the primary instruction cache 110 may be different from that value. As a specific configuration of the primary instruction cache 110, any one of generally known cache memory configurations may be used.

The instruction fetch/decode unit 120 acquires an instruction from the primary instruction cache 110 or the like and then decodes the instruction. In the present exemplary embodiment, the instruction fetch/decode unit 120 is assumed to include a branch prediction function. As the branch prediction function included in the instruction fetch/decode unit 120, any one of generally known branch prediction technologies may be used.

The dependence analysis unit 130 extracts and analyzes dependence between instructions decoded by the instruction fetch/decode unit 120. Further, the dependence analysis unit 130 renames a logical register designated in a decoded instruction into a physical register.

The renaming register 140 is a physical register which actually holds data stored in a logic register renamed by the dependence analysis unit 130. The renaming register 140 is provided with an optional number of entries.

The execution control unit 150 controls the arithmetic operation unit 151, the branch processing unit 152, the memory processing unit 153, the instruction conversion unit 154 and the like, thereby actually executing an instruction for which the dependence analysis and logical register allocation have been completed, where processes up to that for completing the instruction are performed.

The arithmetic operation unit 151 executes an instruction for an arithmetic operation such as addition, subtraction, multiplication or division, or an instruction for a logical operation. The branch processing unit 152 executes a branch instruction. The memory processing unit 153 executes an instruction relating to access to a memory, such as a load instruction to read data from a memory and a store instruction to write data into a memory.

Further, the execution control unit 150 may include a mechanism to execute other kinds of instructions which can be executed by a general processor and to perform a process for completing those instructions.

The primary data cache 160 is a cache memory which holds data stored in the memory 700, other than instruction code, as a cache. The capacity and specific configuration of the primary data cache 160 may be the same as or different from that of the primary instruction cache 110.

The secondary cache 170 is a cache memory at a lower level than the primary instruction cache 110 and the primary data cache 160. For example, the capacity of the secondary cache 170 is larger than that of the primary instruction cache 110 and of the primary data cache 160.

Here, as a specific method for realizing each of the constituent elements of the processor core 100 described above, any one of generally known methods may be used. Further, the configuration of the processor core 100 shown in FIG. 1 is merely an example, and in terms of the above-described constituent elements, the processor core 100 may have any other one of generally known processor configurations.

Next, a description will be given of each of the constituent elements of the instruction conversion unit 154 included in the processor core 100.

When there exists a branch instruction not having been executed in the processor core 100, the conversion section 1541 converts a store instruction for writing data into a predetermined address of the memory 700 into an atomic load-store instruction. Such a state where an unexecuted branch instruction is present (the branch instruction was issued by the execution control unit 150 but has not been executed yet by the branch processing unit 152) is referred to as a speculative state.

Specifically, the conversion section 1541 acquires an instruction relating to memory access, which may be a store instruction, from the execution control unit 150 or the memory processing unit 153. The conversion section 1541 also acquires information indicating that the processor core 100 is currently in a speculative state, from the execution control unit 150 or the branch processing unit 152. Then, if determining that the acquired instruction relating to memory access is a store instruction and also that the processor core 100 is currently in a speculative state, the conversion section 1541 converts the store instruction into an atomic load-store instruction.

The converted atomic load-store instruction is sent to the memory processing unit 153 and executed there. Here, in a case of any memory access instruction other than a store instruction or a store instruction acquired when the processor core 100 is not in a speculative state, the conversion section 1541 sends the instruction to the memory processing unit 153 without converting it. That is, when the processor core 100 is not in a speculative state, the memory processing unit 153 of the processor core 100 executes a store instruction as it is. In executing the atomic load-store instruction, data read out by the instruction is appropriately held in the renaming register 140 using, for example, a procedure shown in a program execution example which will be described later, or the like.

The atomic load-store instruction is an instruction to read data stored in a designated address of the memory 700 and subsequently write data to the address with no interruption by any other process. That is, when the atomic load-store instruction is executed, data reading and data writing (load and store) are performed atomically (sequentially). The atomic load-store instruction is referred to also as a test-and-set mechanism.

Here, an address of the memory 700 being the target of reading by the atomic load-store instruction is equal to an address into which writing is to be performed by the store instruction having been converted into the atomic load-store instruction. That is, data reading performed by the atomic load-store instruction corresponds to an operation of saving data stored in an area defined by the address into the renaming register 140. An address of the memory 700 and data which are to be read by the atomic load-store instruction are respectively equal to those designated in the store instruction having been converted into the atomic load-store instruction. If the data to be read by the atomic load-store instruction is stored in any one of the cache memories, such as the primary instruction cache 110, the data may be read from the cache memory. When the data is stored in a higher level cache memory, it is preferable to read the data from the cache memory.

The store address queue 1542 holds information about correspondence between the address of the memory 700 designated in the store instruction having been converted into the atomic load-store instruction as described above and a register to hold the corresponding data. For example, as such information, the store address queue 1542 holds the number of an entry of the renaming register 140 holding the data having been read by the atomic load-store instruction and the address designated in the store instruction, in a manner of pairing them with each other. The store address queue 1542 stores the information in a manner of holding it in a First-In First-Out (FIFO) list structure.

If a branch prediction with respect to the branch instruction failed, the generation section 1543 generates a store instruction to write data having been read by the atomic load-store instruction. The generation section 1543 generates the store instruction as the one to write data having been read by the atomic load-store instruction into the address from which the data has been read by the atomic load-store instruction (that is, the address designated in the original store instruction). Thus generated store instruction is sent to the memory processing unit 153 and then executed there. Here, it is expected that a plurality of pieces of information (pairs of an entry number of the renaming register 140 and an address) are held in the store address queue 1542. In that case, the generation unit 1543 generates store instructions sequentially such that the store instructions are generated in the reverse order to that of executing corresponding atomic load-store instructions.

(Processor Operation)

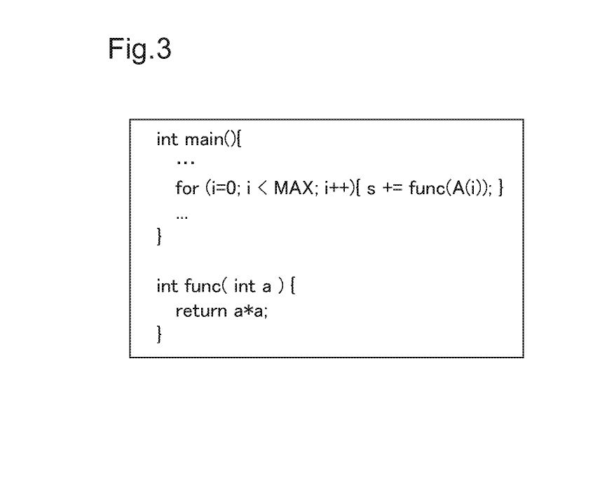

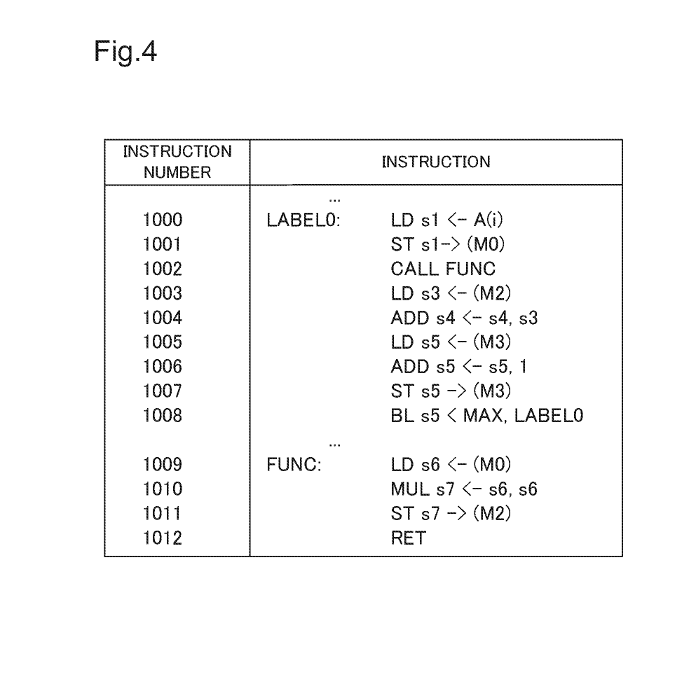

Next, an example of operation of the processor 10 in the present exemplary embodiment will be described. In the present example, execution of a program shown in FIG. 3 is assumed. FIG. 4 shows an example of a machine language level instruction sequence into which the program shown in FIG. 3 is compiled.

The program shown in FIG. 3 is a program described in a programming language such as the C language. The program consists of two parts, that is, a function main( ) corresponding to the main loop and a function func( ).

In the main loop, a loop is constructed by the for-statement. The loop of for-statement is executed taking i as the control variable. That is, the value of i is initially 0, and is incremented by 1 each time the process of executing one cycle of the for-statement loop has been completed. Then, if the i value is smaller than a value held as a variable MAX, the for-statement is executed repeatedly. That is, in the example program shown in FIG. 3, the for-statement loop is repeatedly executed MAX times. In the for-statement loop, the function func is called taking as the argument the value of the function A(i) having i as its argument, and the return value from the function func is added to a variable s and accumulated there.

In the function func, a value of the argument squared is calculated as a return value which is defined to be an int-type variable, that is, an integer type variable with sign. In the program shown in FIG. 3, the value of A(i) is squared to be the return value.

On the other hand, in the instruction sequence shown in FIG. 4, the instructions of the instruction numbers from 1000 to 1008 correspond to the main loop of the program shown in FIG. 3. The instructions of the instruction numbers from 1009 to 1012 correspond to the function func shown in FIG. 3. An outline of the instruction sequence is as follows.

In the instruction sequence shown in FIG. 4, with regard to the main loop, first, by the instruction numbered 1000, the value of A(i) is read and then stored into a register s1. The LD instruction is a load instruction to read a value described on the right of the arrow and store it into a register designated on the left of the arrow. Next, by the instruction numbered 1001, the value stored in the register s1 (that is, the value of A(i)) is written into an area of the memory 700 which is defined by an address M0. The area of the address M0 is an area for storing the argument to be passed to the function func. The ST instruction is a store instruction to write a value designated on the left of the arrow into a memory address designated on the right of the arrow. Then, by the instruction numbered 1002, executed is a CALL instruction to call a function whose corresponding instructions are stored in a location designated by a label FUNC. That is, the CALL instruction corresponds to calling of the function func in the program shown in FIG. 3. By the execution of the CALL instruction, the process branches to the instruction numbered 1009 to which the Label FUNC is assigned.

Subsequently, a process for the function func is executed. In the process for the function func, first, by the instruction numbered 1009, executed is an LD instruction to read a value stored in the area defined by the address M0, where the argument is stored, and to store the value into a register s6. Next, the square of the value having been stored in the register s6 by the instruction numbered 1009 is calculated. Thus calculated value is stored into a register s7. The MUL instruction is an instruction to perform multiplication between respective values stored in two registers designated on the right of the arrow and to store the result into a register designated on the left of the arrow. This process step corresponds to the process of calculating the square of the argument by the function func in the program shown in FIG. 3. Next, by execution of the ST instruction corresponding to the instruction numbered 1011, the value stored in the register s7 is stored into an area of the memory 700 which is defined by an address M2. The area defined by the address M2 is an area for storing a return value from the function func. Next, by execution of the instruction numbered 1012, the process for the function FUNC is ended. The RET instruction is an instruction to jump to an instruction subsequent to the CALL instruction numbered 1002 having caused the calling of the function FUNC (that is, the instruction numbered 1003).

Thus returning back to the main loop, by the LD instruction described as the instruction number 1003, the return value from the function FUNC stored in the area of the memory 700 defined by the address M2 is read and then stored into a register s3. Then, by the instruction described as the instruction number 1004, a value obtained by adding together the value stored in the register s3 and that stored in a register s4 is stored into the register s4. The ADD instruction is an instruction to add together respective values stored in two registers designated on the right of the arrow and to store the result into a register designated on the left of the arrow. This instruction corresponds to the process of adding a return value from the function func in an accumulating manner in the program shown in FIG. 3.

Next, by the LD instruction described as the instruction number 1005, the value stored in the area of the memory 700 defined by the address M3 is read and then stored into a register s5. The value stored at the address M3 corresponds to a value of the for-statement control variable i in the program shown in FIG. 3. Subsequently, by the ADD instruction described as the instruction number 1006, addition of 1 to the value stored in the register s5 is calculated, and the resultant value is stored into the register s5. Then, by the ST instruction described as the instruction number 1007, the value stored in the register s5 is stored into the area defined by the address M3. This series of process steps corresponds to the process of adding 1 to a value of the for-statement control variable i in the program shown in FIG. 3.

Next, by the instruction described as the instruction number 1008, the value stored in the register s5 is compared with a value MAX and, if the value stored in the register s5 is smaller than the value MAX, branching to the label LABEL0 is made. This process step corresponds to the operation in the program shown in FIG. 3 where the for-statement loop is repeated if a value of the for-statement control variable i is smaller than the value MAX. If the value stored in the register s5 is equal to or larger than the value MAX, an instruction subsequent to the instruction numbered 1008 is executed. The BL instruction is a conditional branch instruction to cause branching to a label designated by the second argument if a condition designated by the first argument is satisfied, and cause execution of the subsequent instruction if the condition is not satisfied.

The processor core 100 of the processor 10 executes the above-described program shown in FIG. 4, which is an instruction sequence in machine language, as follows.

In the following example of executing the program, it is assumed that the value of A(i) and the values stored in the areas of the memory 700 designated respectively by the addresses M0 and M2 are stored in the primary data cache 160. It is also assumed that, however, the value stored in the area of the memory 700 defined by the address M3, which corresponds to the for-statement control variable i, is not stored in any of the cache memories provided in the processor 10. Such a situation is the one which may generally occur in usual program execution.

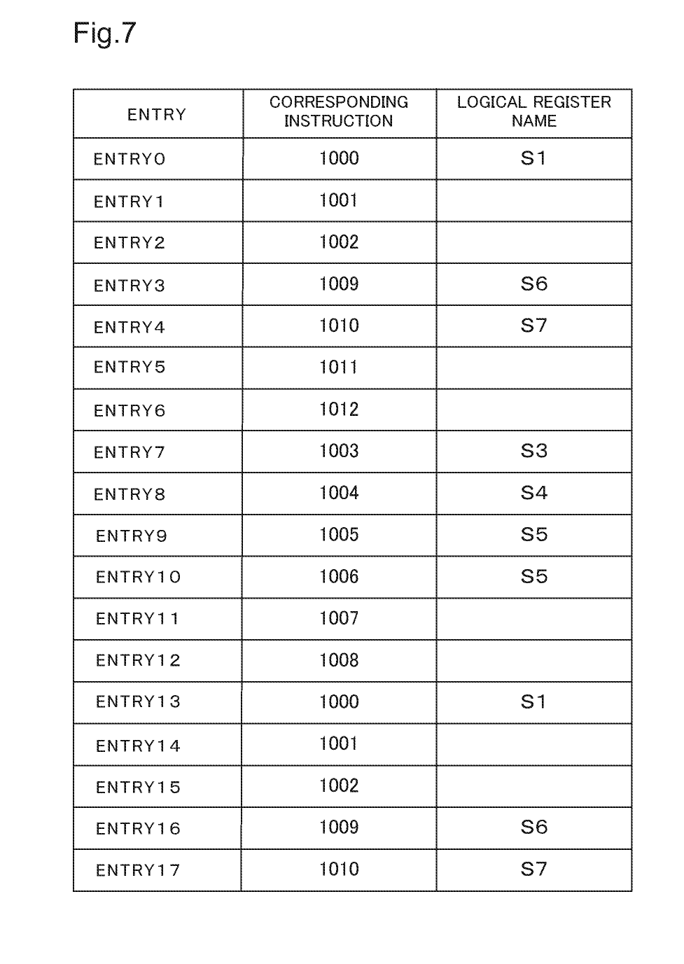

FIG. 7 shows correspondence between instructions and entries which are physical registers provided in the renaming register 140. In the example shown in FIG. 7, the entries of the renaming register are sequentially assigned to the instructions decoded by the instruction fetch/decode unit 120. In this example of execution, an entry is assigned to even an instruction requiring no logical register to be the storing destination, such as an ST instruction. For example, in the example shown in FIG. 7, the entry 11 is assigned to the ST instruction described as the instruction number 1007. The correspondence shown in FIG. 7 is held by the renaming register 140, for example, but it may be held by another constituent element of the processor core 100.

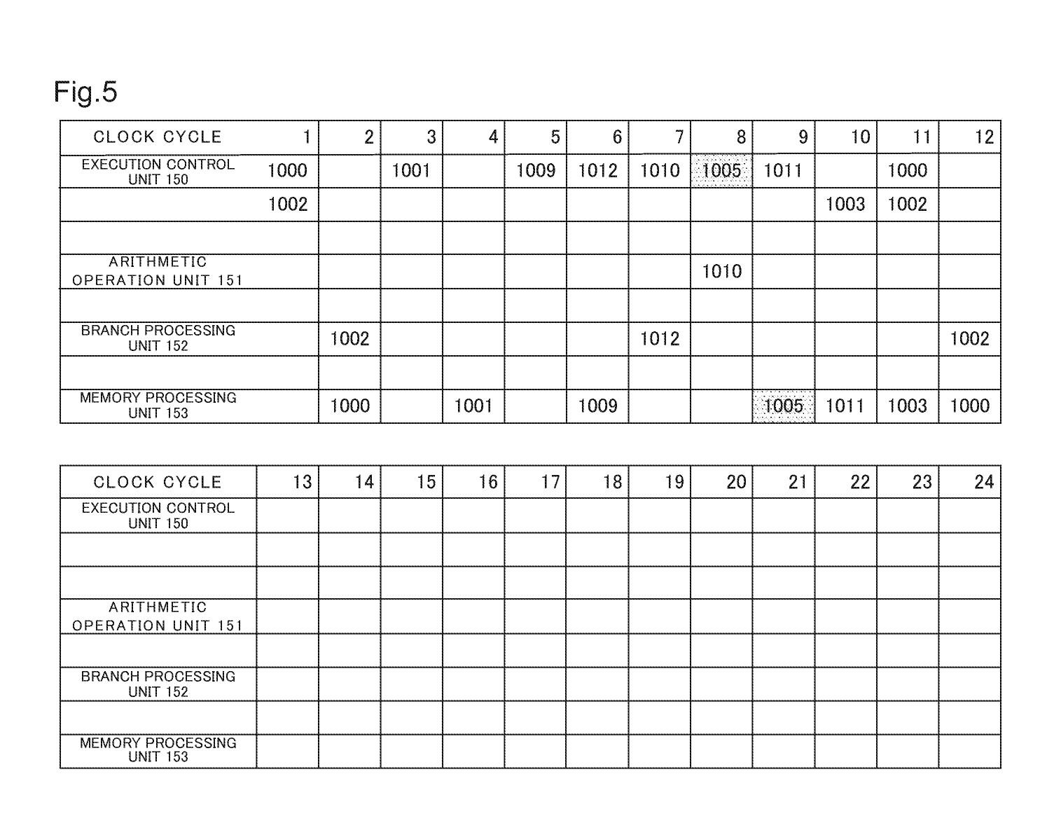

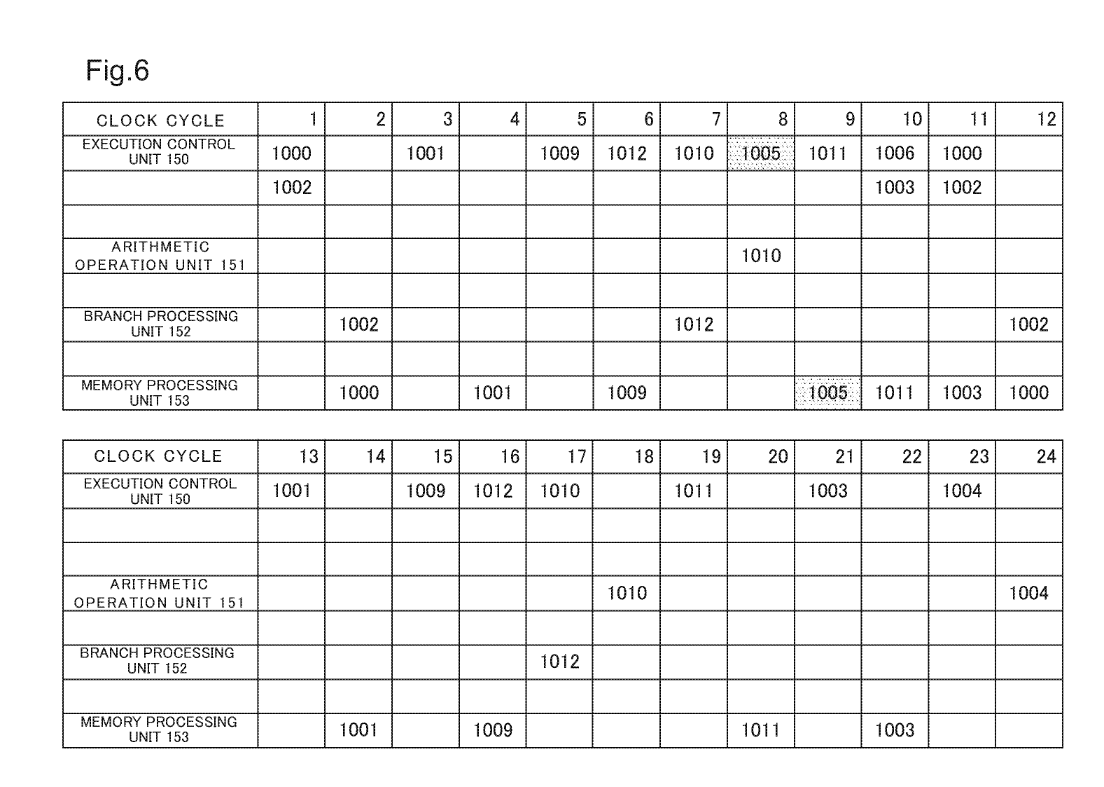

FIGS. 5 and 6 each show an example of a timing chart in a case where the processor core 100 of the processor 10 executes the instruction sequence shown in FIG. 4. FIGS. 5 and 6 are each a timing chart showing operations of the constituent elements of the processor core 100 in each one of 24 clock cycles starting from the clock cycle 1, in the execution of the instruction sequence shown in FIG. 4 by the processor core 100.

Here, FIG. 5 is an example of a timing chart in a case where the instruction conversion unit 154 included in the processor 10 is disabled (that is, the instruction conversion unit 154 does not operate). On the other hand, FIG. 6 is an example of a timing chart in a case where the instruction conversion unit 154 included in the processor 10 is enabled (that is, the instruction conversion unit 154 does operate).

In executing the timing charts shown in FIGS. 5 and 6, the following assumptions are made about the execution by the processor 10. It is assumed that the execution control unit 150 can issue up to two instructions simultaneously in one clock cycle. Each instruction issued by the execution control unit 150 is executed by any one of the arithmetic operation unit 151, the branch processing unit 152 and the memory processing unit 153, in accordance with the instruction type. In the present case, each instruction is executed in the next cycle of the cycle in which it is issued by the execution control unit 150. It is also assumed that two clock cycles are required for executing an instruction in the arithmetic operation unit 151 or the memory processing unit 153. Accordingly, if a later-issued instruction directly uses a result of execution of a previously-issued instruction by the arithmetic operation unit 151 or the memory processing unit 153, the later-issued instruction needs to be issued, by the execution control unit 150, at least two clock cycles later than the previously-issued instruction to be executed by the arithmetic operation unit 151 or the memory processing unit 153. It is further assumed that the execution control unit 150 can perform out-of-order execution. That is, the execution control unit 150 can issue instructions whose mutual dependence is dissolved (which have no mutual dependence) in a different order from that in the original program. The program shown in FIG. 4 consists of a simple branch/call and a loop. Accordingly, it is assumed that, by branch prediction performed by the instruction fetch/decode unit 120, a subsequent correct instruction is supplied without waiting for execution of the branching, in the pipeline of the processor 10.

In the timing charts shown in FIGS. 5 and 6, the processor core 100 operates in the same way from the first clock cycle to the ninth clock cycle. First, in the clock cycle 1, the execution control unit 150 issues the LD instruction described as the instruction number 1000 and the CALL instruction described as the instruction number 1002 simultaneously. Because the LD instruction is executed by the memory processing unit 153, two cycles are required for executing it.

Then, when the ST instruction described as the instruction number 1001 is executed by the memory processing unit 153, a value having been stored into the register s1 as a result of executing the LD instruction numbered 1000 is referred to. Therefore, the execution control unit 150 issues the ST instruction numbered 1000 in the clock cycle 3 corresponding to a clock cycle which is two cycles after the clock cycle in which the LD instruction numbered 1000 is issued.

When the LD instruction described as the instruction number 1009 is executed by the memory processing unit 153, a value having been stored by the ST instruction numbered 1001 into the area defined by the address M0 is read. Therefore, the execution control unit 150 issues the LD instruction numbered 1009 in the clock cycle 5 which is two cycles after the clock cycle 3 corresponding to a clock cycle in which the ST instruction numbered 1001 is issued. Similarly, when the arithmetic operation unit 151 executes the MUL instruction described as the instruction number 1010, the value having been read and then stored into the register s6 by the LD instruction numbered 1009 is referred to. Therefore, the execution control unit 150 issues the MUL instruction numbered 1010 in the clock cycle 7 which is two cycles after the clock cycle 5 corresponding to a clock cycle in which the LD instruction numbered 1009 is issued.

Then, as a result of execution of the ST instruction described as the instruction number 1011 by the memory processing unit 153, the value having been obtained by the MUL instruction numbered 1010 executed by the arithmetic operation unit 151 is stored into the area of the memory 700 defined by the address M2. Therefore, the execution control unit 150 issues the ST instruction numbered 1011 in the clock cycle 9 which is two cycles after the clock cycle 7 corresponding to a clock cycle in which the MUL instruction numbered 1010 is issued. The value thus stored in the area defined by the address M2 corresponds to a return value from the function func.

On the other hand, the RET instruction described as the instruction number 1012, which corresponds to return from the function func, has no dependency on any preceding instruction. Accordingly, the RET instruction may be executed independently of any preceding instruction. The execution control unit 150 issues the RET instruction in the clock cycle 6. The return value from the function func which was stored in the area defined by the address M2, as described above, is read into the register s3 as a result of execution of the LD instruction described as the instruction number 1003 by the memory processing unit 153. As a result of subsequent execution of the ADD instruction described as the instruction number 1004 by the arithmetic operation unit 151, the return value is stored into the register s4 in an accumulatively adding manner.

After that, the execution control unit 150 issues the LD instruction described as the instruction number 1005 in the clock cycle 8, because there is no dependence of the LD instruction on any of the above-described instructions. The LD instruction numbered 1005 reads the value stored in the area of the memory 700 defined by the address M3 and loads the value into the register s5. However, as assumed above, the value stored in the area defined by the address M3 is not stored in any one of the cache memories provided in the processor 10. Therefore, it is possible that several tens or hundreds cycles are required to complete the storing of the value read by the LD instruction into the register s5. In that situation, the execution control unit 150 may issue the LD instruction numbered 1000 and the CALL instruction numbered 1002 for the next loop, because these instructions have no dependence on the LD instruction numbered 1005. Those instructions are executed by the branch processing unit 152 or the memory processing unit 153.

In contrast, execution of the BL instruction described as the instruction number 1008 and so on is suspended, because operands of the instructions have dependence on the LD instruction numbered 1005. That is, execution of the BL instruction described as the instruction number 1008 and so on is suspended until execution of the LD instruction numbered 1005 is completed. Accordingly, when the instruction conversion unit 154 is disabled in the processor 10, the execution control unit 150 cannot issue subsequent instructions, as shown in FIG. 5. As a result, execution of instructions subsequent to the LD instruction is suspended.

On the other hand, when the instruction conversion unit 154 is enabled in the processor 10, the processor 10 operates as follows, in accordance with the timing chart shown in FIG. 6, after the LD instruction numbered 1005 is issued. In the present example, it is assumed that the instruction fetch/decode unit 120 has predicted that the branch instruction relating to the loop corresponding to the for-loop shown in FIG. 3 is executed such that the loop is executed repeatedly.

In the case where the instruction conversion unit 154 is enabled, subsequently to the LD instruction numbered 1005, the execution control unit 150 executes the ST instruction described as the instruction number 1001 corresponding to execution of the next loop relating to the for-statement in the program shown in FIG. 3. Here, the ST instruction is an instruction for which whether its execution is proper or not is determined according to a result of executing the above-described BL instruction numbered 1008. In the present case, the constituent elements of the instruction conversion unit 154 operate as follows.

In the instruction conversion unit 154, when the ST instruction numbered 1001 is executed, the conversion section 1541 appropriately acquires information about whether the processor core 100 is in a speculative state or not, from the execution control unit 150 or the branch processing unit 152. Because the processor core 100 is in a speculative state in the present case, the conversion section 1541 converts the ST instruction into an atomic load-store instruction and sends it to the memory processing unit 153. The memory processing unit 153 receives the atomic load-store instruction produced by the conversion by the conversion section 1541, as the ST instruction, and executes it.

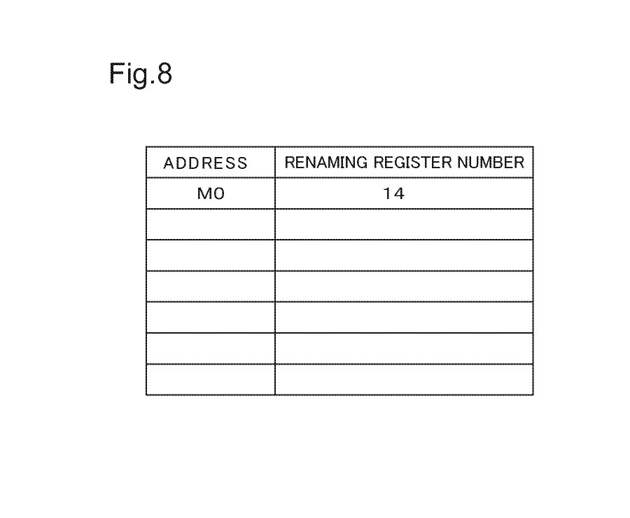

In association with the execution of the atomic load-store instruction, the memory processing unit 153 registers into the store address queue 1542 information about correspondence between the renaming register 140 and an address of the memory 700 to which writing is performed by the above-described ST instruction. As shown in FIG. 7, the ST instruction numbered 1001 in the present case is correlated with the entry 14 of the renaming register 140. Accordingly, information indicating that the address M0, which is the address of the memory 700 to which writing is performed by the above-described ST instruction, is correlated with the entry 14 of the renaming register 140 is registered into the store address queue 1542. FIG. 8 shows the store address queue 1542 where the above-described information has been registered.

Of the atomic load-store instruction, the memory processing unit 153 executes the load operation first. That is, the memory processing unit 153 reads data which is already stored, at the time of the execution, in the area defined by the address M0 into which data is to be stored by the ST instruction numbered 1001. At that time of the reading, a value A(i-1), which is a value of A(i) having been written at the time of last execution of the loop, is already stored in the area defined by the address M0. In the load operation, if the data stored in the area defined by the address M0 is stored in any one of the caches provided in the processor 10, the data may be read from the cache storing the data. In that case, it is preferable that the data is read from the highest level one of the caches storing the data. Then, the memory processing unit 153 writes thus read value into the above-described entry of the renaming register 140 corresponding to the ST instruction. As already described, the ST instruction numbered 1001 in the present case is correlated with the entry 14 of the renaming register 140. Therefore, the memory processing unit 153 writes the read data described above into the entry 14 of the renaming register 140.

Next, the memory processing unit 153 executes the store operation of the atomic load-store instruction speculatively. The store operation is executed immediately after the load operation with no interruption by any other process. An area into which a value is written by the store operation and the value to be thus written are respectively the same as those designated in the ST instruction numbered 1001 before conversion. Here, the memory processing unit 153 does not execute a process of completing the store operation (retire process) before the above-described BL instruction described as the instruction number 1008 is actually executed and it accordingly is finally determined whether the execution of the store operation is proper or not.

As a result of the execution of the atomic load-store instruction by the memory processing unit 153 in the above-described way, even in the speculative state, a value already stored in the memory before the execution of the above-described store operation has been stored into the renaming register 140. Accordingly, even if the branch prediction by the instruction fetch/decode unit 120 with respect to the BL instruction numbered 1008 failed, it is possible to restore the value stored in the memory to that stored before the speculative execution of the store operation. Thus, as a result of the instruction conversion unit 154 being enabled, even in the speculative state, subsequent instructions may be executed during execution of the loop.

Here, whether the execution of the store operation executed as the atomic load-store instruction is proper or not is determined after completion of the branch instruction, which is precedent to the corresponding store instruction and has not been executed yet at the time of the execution of the store operation. In the present example of execution, whether the execution of the store operation is proper or not is determined according to execution of the BL instruction numbered 1008 based on of a value read by the above-described LD instruction numbered 1005 from the area of the memory 700 defined by the address M3.

If the branch prediction by the instruction fetch/decode unit 120 succeeds, the memory processing unit 153 executes a complete (retire) process for the store operation. In the present exemplary embodiment, the case of success in branch prediction corresponds to a case where a loop corresponding to the for-loop shown in FIG. 3 has come to be repeated again. If there is any store operation under execution, the memory processing unit 153 executes a completion process including the store operation. Then, the memory processing unit 153 releases the corresponding entry registered in the store address queue 1542.

On the other hand, if the branch prediction failed (if the above-described loop is no longer repeated, in the present exemplary embodiment), the store generation section 1543 of the instruction conversion unit 154 restores the state of the memory 700 to that before the execution of the speculative store operation. For a specific example, the store generation section 1543 performs the following operation.

The store generation section 1543 reads information about a plurality of correspondences stored in the store address queue 1542 sequentially in order from the most recently registered piece of the information to the most previously registered one. In the present example of execution, as shown in FIG. 8, the information about the correspondence between the address M0 of the memory 700 and the entry 14 of the renaming register 140 is read.

Then, referring to the renaming register 140 based on the information read from the store address queue 1542, the store generation section 1543 reads a value stored in the renaming register 140. In the present example of execution, the store generation section 1543 reads a value stored in the entry 14 of the renaming register 140. In the entry 14, stored is data which was stored in the address M0 of the memory 700 before the execution of the store operation of the atomic load-store instruction. That data corresponds to the value A(i-1) which was written at the time of last execution of the loop relating to the ST instruction numbered 1001 converted into the above-described atomic load-store instruction.

Next, the store generation section 1543 generates an ST instruction to write the value read from the renaming register 140, as described above, into an address designated by the information read from the store address queue 1542. In the present example of execution, the store generation section 1543 generates an ST instruction to write the value A(i-1) read from the entry 14 of the renaming register 140 into an area of the memory 700 defined by the address M0.

Then, the store generation section 1543 executes the generated ST instruction. There, the store generation section 1543 executes the ST instruction taking any one of the cache memories provided in the processor 100 or the memory 700 as the target.

That is, in the present example of execution, if the data stored in the address M0 is stored also in any one of the cache memories provided in the processor 100, the store generation section 1543 executes the ST instruction taking the cache memory storing the data as the target. If the data stored in the address M0 is stored in none of the cache memories provided in the processor 100, the store generation section 1543 executes the ST instruction taking the memory 700 as the target. Further, in the present case, the store generation section 1543 may send the ST instruction to the memory processing unit 153, and the memory processing unit 153 may then execute the ST instruction.

If the store address queue 1542 holds information about a plurality of correspondences, the store generation section 1543 executes the above-described operation repeatedly to execute it with respect to all of the plurality of correspondences held by the store address queue 1542.

In that case, the store generation section 1543 executes the above-described operation with respect to the plurality of correspondences stored in the store address queue 1542 in order from the most recently registered piece of the information to the most previously registered one.

The above-described operation in the case of failed branch prediction generally requires a large number of clock cycles for its execution. That is, the above-described operation is usually a high cost process. However, it is assumed that, by employing a generally known branch prediction technology as the branch prediction function provided in the instruction fetch/decode unit 120, probability of failure in the branch prediction becomes very small. That is, it is assumed that, when a general program is executed by the processor 10 in the present exemplary embodiment, the frequency of occurrence of the above-described operation in the case of failed branch prediction is very small. Accordingly, the instruction conversion unit 154 contributes to improvement in the performance of the processor 10.

As has been described above, the processor 10 in the first exemplary embodiment of the present invention includes the instruction conversion unit 154 provided with the conversion section 1541, the store address queue 1542 and the generation section 1543.

In a speculative state, the conversion section 1541 converts a store instruction into an atomic load-store instruction. The atomic load-store instruction is an instruction to execute a load operation to save, into the renaming register 140, data already held in an area of a memory or the like into which data is to be written by the above-described store instruction, and to execute also a store operation corresponding to the store instruction. Thereby, it becomes possible for the processor 10 in the present exemplary embodiment to speculatively execute the store instruction in a speculative state and, if branch prediction with respect to the speculative state failed, restore the value which was stored in the memory.

When the atomic load-store instruction is executed, the store address queue 1542 stores information about correspondence between an address of the memory 700 and an entry of renaming register 140 holding a value which was stored in the address. In the above-described case where branch prediction with respect to the a speculative state has failed, the generation section 1543 generates a store instruction to write the value which was held before the execution of the atomic load-store instruction into an area of the memory, or the like, into which a value has been written by the atomic load-store instruction. Thereby, it becomes possible to actually restore the value stored in the memory, in the case where branch prediction relating to the atomic load-store instruction has failed.

As a result, the processor 10 in the present exemplary embodiment makes possible a store operation in a speculative state by the simple configuration.

In the present exemplary embodiment, a configuration of the processor 10 and a method for implementing it are optional. What is required of the processor 10 (or the processor core 100) is only to include the constituent elements (at least the conversion section 1541) of the instruction conversion unit 154. As the configuration of the processor 10 (or the processor core 100) except for the instruction conversion unit 154, any configuration capable of executing general memory access instructions, such as the above-described LD and ST instructions, may be employed. An instruction set which can be executed by the processor 10 may include any instructions, as long as it includes general memory access instructions such as the above-described LD and ST instructions.

Further, in the present exemplary embodiment, a method for implementing the constituent elements included in the instruction conversion unit 154 is optional. For example, the conversion section 1541 and the generation section 1543 may be implemented together as a single circuit or functional block.

When writing data into a memory hierarchy in a speculative state, it may become necessary to hold the history or the like of data having been held in a memory area to be the target of the writing. However, the technology of Patent Literature 1 or the like has a problem in that the configuration required for executing data writing into the memory hierarchy in a speculative state is complicated.

According to the present invention, it becomes possible to provide a processor or the like which enables store operation in a speculative state by means of a simple configuration.

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

What is claimed is:

1. A processor comprising:
a converter configured to convert a first store instruction into a load-store instruction when a branch instruction yet to be executed exists, the first store instruction being an instruction to write first data into a predetermined address and the load-store instruction being an instruction to sequentially execute reading of second data stored in the address and writing of the first data into the address.

2. The processor according to claim 1, further comprising:
a generator configured to generate a second store instruction to write the second data into the address if prediction about branching of the branch instruction failed.

3. The processor according to claim 1, further comprising:
a store address queue configured to hold a relationship between the address and information about a register storing the second data read by the load-store instruction.

4. The processor according to claim 2, further comprising:
a store address queue configured to hold a relationship between the address and information about a register storing the second data read by the load-store instruction.

5. The processor according to claim 2, wherein the generator generates the second store instruction based on the relationship held by the store address queue.

6. The processor according to claim 3, wherein the generator generates the second store instruction based on the relationship held by the store address queue.

7. The processor according to claim 4, wherein the generator generates the second store instruction based on the relationship held by the store address queue.

8. The processor according to claim 5, wherein, when a plurality of the relationships are held by the store address queue, the generator generates the second store instruction with respect to each of the plurality of relationships in the reverse order to that of storing the plurality of relationships into the store address queue.

9. The processor according to claim 1, further comprising:
a memory processor configured to execute at least the load-store instruction.

10. The processor according to claim 9, wherein, when the prediction about branching of the branch instruction has succeeded, the memory processor executes a process of completing the load-store instruction.

11. The processor according to claim 9, wherein the memory processor executes the first store instruction when no branch instruction yet to be executed exists.

12. The processor according to claim 10, wherein the memory processor executes the first store instruction when no branch instruction yet to be executed exists.

13. An information processing device comprising:
the processor according to claim 1; and
a memory.

14. A method for converting a store instruction comprising:
converting a first store instruction into a load-store instruction when a branch instruction yet to be executed exists, the first store instruction being an instruction to write first data into a predetermined address and the load-store instruction being an instruction to sequentially execute reading of second data stored in the address and writing of the first data into the address;
holding information indicating a relationship between the address and information about a register storing the second data read by the load-store instruction; and
generating a second store instruction to write the second data into the address if prediction about branching of the branch instruction failed.
